(19) United States
(12) Patent Application Publication
(10) Pub. No.: US 2002/0079166 A1
(43) Pub. Date: Jun. 27, 2002

(54) Safety latch device for an extension ladder system

(76) Inventor: Casey Walter Gaik, Oak Brook, IL (US)

Correspondence Address: Emery L. Tracy, P.O. Box 1518, Boulder, CO, 80306-1518, US

(21) Appl. No.: 10/087,546

(22) Filed: Mar. 1, 2002

Related U.S. Application Data
(63) Continuation-in-part of application No. 09/366,825, filed on Aug. 4, 1999, now abandoned.

(51) Int. Cl. E06C 7/06

(52) U.S. Cl. 182/211; 182/213

(57) ABSTRACT

An extension ladder assembly is provided. The extension ladder assembly comprises a base section having a pair of base section rails and a plurality of base section rungs mounted between the base section rails and at least one fly section having a pair of fly section rails and a plurality of fly section rungs mounted between the fly section rails. At least one rung lock is secured to at least one of the fly section rails and selectively, releasably positionable about at least one base section rung to inhibit movement of the fly section in a generally downward direction. A latching member is rotationally mounted to each rung lock with the latching member selectively movable from a released position to a tensioned position. A biasing mechanism biases the latching member into the released position wherein in the released position, the latching member contacts the same base section rung as each corresponding rung lock.

The present application is a continuation-in-part of pending patent application Ser. No. 09/366,825, filed on Aug. 4, 1999, entitled “Safety Latch Device for an Extension Ladder System”.

### BACKGROUND OF THE INVENTION

1. Field of the Invention

This invention relates generally to an extension ladder having a base section and one or more fly sections with at least one rung lock for maintaining the extension of the fly sections relative to the base section and, more particularly, it relates to a safety latch device connected to the rung lock which inhibits a fly section of the extension ladder, when extending from the base section, from accidentally retracting and unintentionally descending toward the base section upon failure or accidental release of the rung lock.

2. Description of the Prior Art

Extension ladders typically consist of a base section and one or more fly sections with each fly section extendible from the preceding section. The term “base section” shall be used herein to refer to the lower of two adjacent sections of an extension ladder, from which a fly section is extended upward. Thus, a “base section” may be the section of the ladder onto which the user first climbs, or may be a fly section extending from a previous base section, from which another fly section is extendible.

Most extension ladders rely on rung locks to hold a fly section in place once it has been extended from a base section. Rung locks are typically attached at one end to the interior of the dual rails on the fly section, in a manner which permits an open jaw at the other end of the rung locks to engage a rung on the base section. For ease in extending and contracting the fly section, rung locks are pivotally mounted so that they may be swung away from the rungs of the base section while the fly section is moved up or down.

Failure to properly engage rung locks is a frequent cause of ladder accidents. Falls from ladders account for a tremendous amount of emergency room admissions each year. “Telescoping” of extension ladders due to false latching or improperly engaged rung locks precipitate many such accidents. If a rung lock is not properly engaged, the fly section of the extension ladder may telescope or descend in a rapid and uncontrolled manner, causing the user to fall. The potential danger is exacerbated by the fact that misaligned rung locks are not always observable from the ground.

In some cases, rung locks may be only partially misaligned, permitting the fly section to be held in place while the user ascends the ladder. However, forces associated with the descent of the user may cause the improperly engaged rung locks to become disengaged, resulting in automatic retraction of the fly section with increasing velocity, accelerating under gravitational force, until the fly section is fully retracted with the base section. The largely uncontrolled high-speed retraction can be dangerous to both bystanders and those who are using the extension ladder.

Accordingly, there exists a need for a safety latch device for an extension ladder which prevents the fly section from fully retracting into the base section. Additionally, a need exists for a safety latch device for an extension ladder which is automatically activated to prevent the fly section from fully retracting into the base section. Furthermore, there exists a need for a safety latch device for an extension ladder which can be added to an existing extension ladder and prevents the fly section from fully retracting into the base section. Further yet, a need exists for a safety latch device which is simple in construction and minimal in cost.

### SUMMARY

The present invention is an extension ladder assembly. The extension ladder assembly comprises a base section having a pair of base section rails and a plurality of base section rungs mounted between the base section rails and at least one fly section having a pair of fly section rails and a plurality of fly section rungs mounted between the fly section rails. At least one rung lock is secured to at least one of the fly section rails and selectively, releasably positionable about at least one base section rung to inhibit movement of the fly section in a generally downward direction. A latching member is rotationally mounted to each rung lock with the latching member selectively movable from a released position to a tensioned position. A biasing mechanism biases the latching member into the released position wherein in the released position, the latching member contacts the same base section rung as each corresponding rung lock.

In addition, the present invention includes a latching system for inhibiting unintentional retraction of an extension ladder. The extension ladder has a base section and at least one fly section extendible from a preceding section with the base section having a pair of base section rails and a plurality of base section rungs mounted between the base section rails and each fly section having a pair of fly section rails and a plurality of fly section rungs mounted between the fly section rails. The latching system comprises at least one rung lock securable to at least one of the fly section rails and selectively, releasably positionable about at least one base section rung to inhibit movement of the fly section in a generally downward direction. Latching means are connected to each rung lock for contacting the same base section rung as the associated rung lock. Tensioning means apply tension to the latching means and rotating means rotate the latching means into contact with the base section rung upon release of the tension.

The present invention further includes a method for inhibiting unintentional lowering of a fly section of an extension ladder with respect to a base section of the extension ladder. The base section has a pair of base section rails and a plurality of base section rungs mounted between the base section rails. The fly section has a pair of fly section rails and a plurality of fly section rungs mounted between the fly section rails. The method comprises mounting at least one rung lock to at least one of the fly section rails, contacting one of the base section rungs with the rung lock, mounting a latching member to at least one of the rung locks, biasing the latch member into a tensioned position, and pivoting the latch member into a released position contacting the same base section rung as the rung lock.

### BRIEF DESCRIPTION OF THE DRAWINGS

FIG. 1 is an exploded view illustrating an embodiment of the safety latch device for an extension ladder, constructed in accordance with the present invention;

FIG. 2 is a perspective view illustrating the embodiment of the safety latch device for an extension ladder of FIG. 1, constructed in accordance with the present invention, with the assembled safety latch device being in a tensioned position;

FIG. 3 is a perspective view illustrating the embodiment of the safety latch device for an extension ladder of FIG. 1, constructed in accordance with the present invention, with the assembled safety latch device being in a released position;

FIG. 4 is an exploded view illustrating another embodiment of the safety latch device for an extension ladder, constructed in accordance with the present invention;

FIG. 5 is an exploded view illustrating still another embodiment of the safety latch device for an extension ladder, constructed in accordance with the present invention;

FIG. 6 is a perspective view illustrating the embodiment of the safety latch device for an extension ladder of FIG. 5, constructed in accordance with the present invention, with the assembled safety latch device being in a tensioned position;

FIG. 7 is a perspective view illustrating the embodiment of the safety latch device for an extension ladder of FIG. 5, constructed in accordance with the present invention, with the assembled safety latch device being in a tensioned position;

FIG. 8 is a perspective view illustrating the embodiment of the safety latch device for an extension ladder of FIG. 1, constructed in accordance with the present invention, with the safety latch device being mounted to the extension ladder; and

FIG. 9 is another perspective view illustrating the embodiment of the safety latch device for an extension ladder of FIG. 1, constructed in accordance with the present invention.

### DETAILED DESCRIPTION OF THE PREFERRED EMBODIMENTS

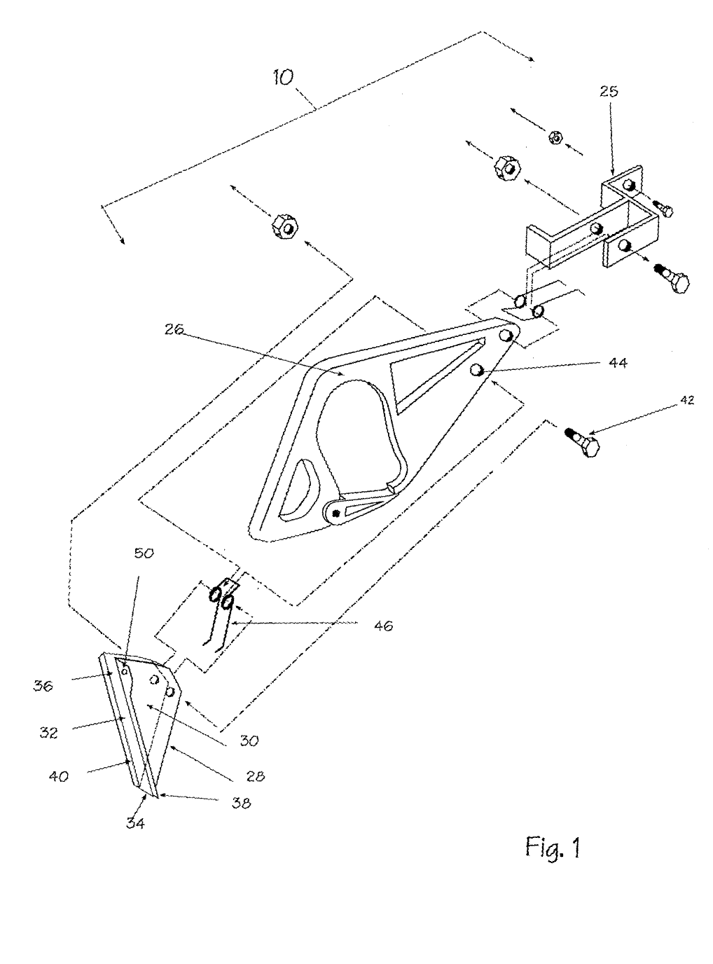

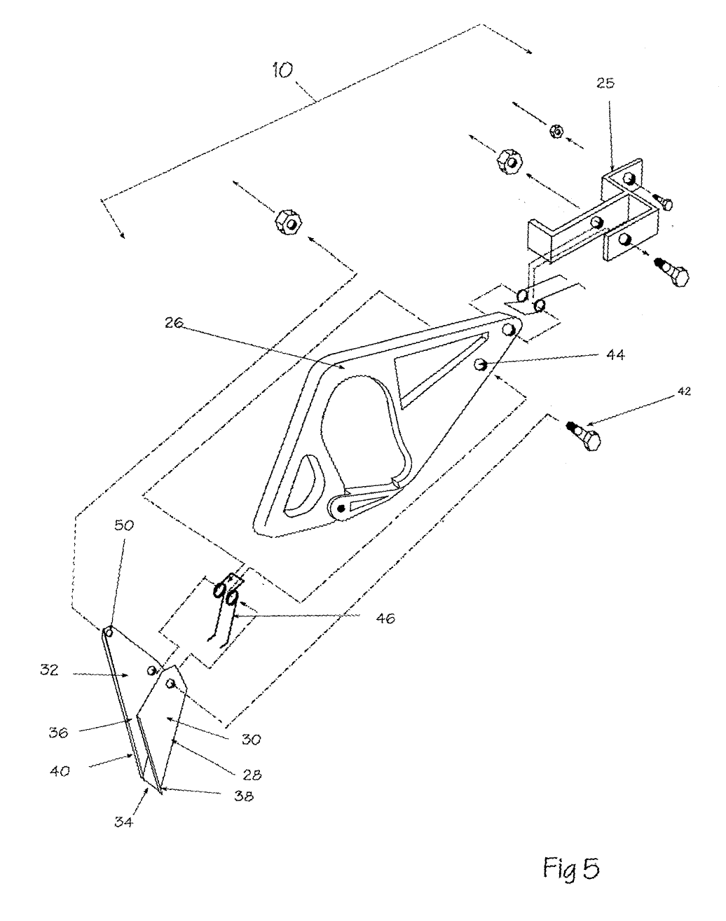

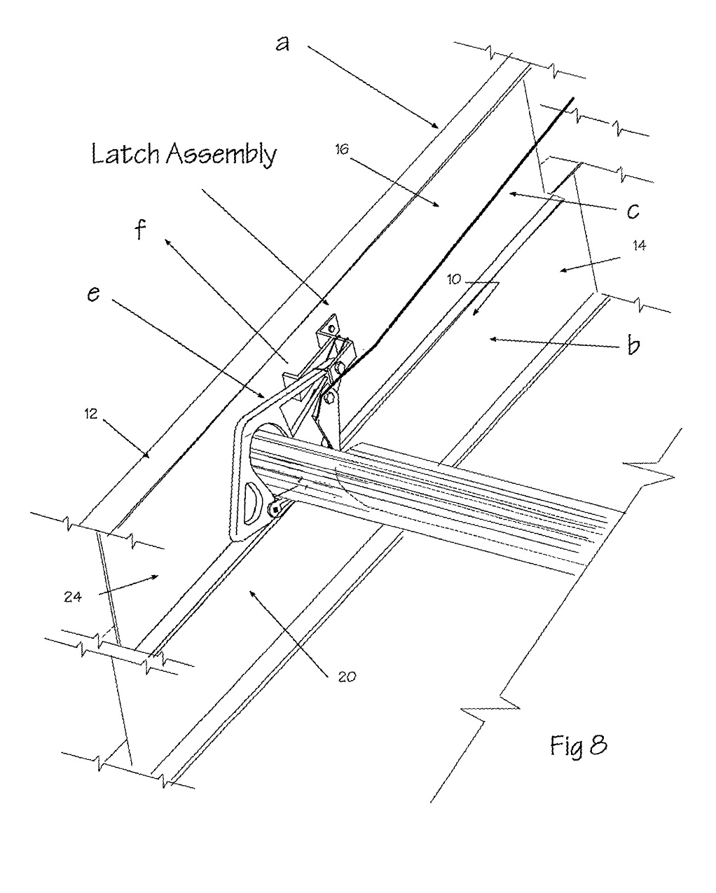

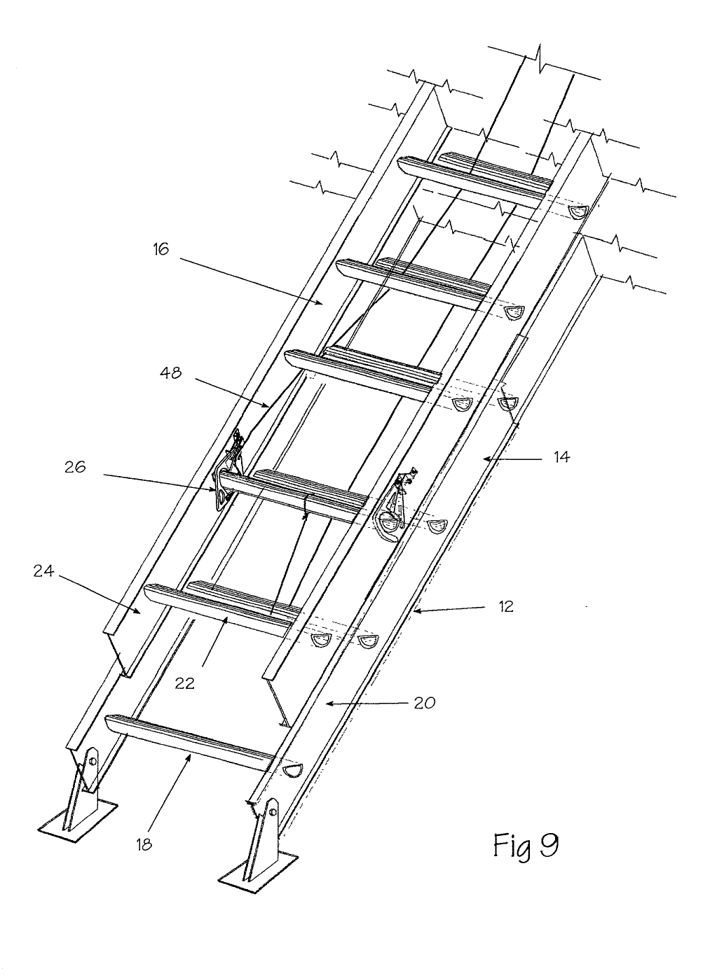

As illustrated in FIGS. 1-7, the present invention is a safety latch device, indicated generally as 10, for an extension ladder 12. As illustrated in FIGS. 8 and 9, the extension ladder 12 includes a base section 14 and at least one fly section 16 with each fly section 16 extendible from the preceding section, either the base section 14 or other fly section 16. The base section 14 includes a plurality of base rungs 18 mounted between a pair of base rails 20 and the fly section includes a plurality of fly rungs 22 mounted between a pair of fly rails 24. At least one spring-biased rung lock 26 is mounted to a fly rail 24 of the fly section 16 by a bracket 25 and rotates to engage a particular, desired base rung 18 on the base section 14 at a location desired by the user. The rung locks 26, when properly engaged, act to maintain the fly section 16 in a desired position relative to the base section 14 during use of the extension ladder 12.

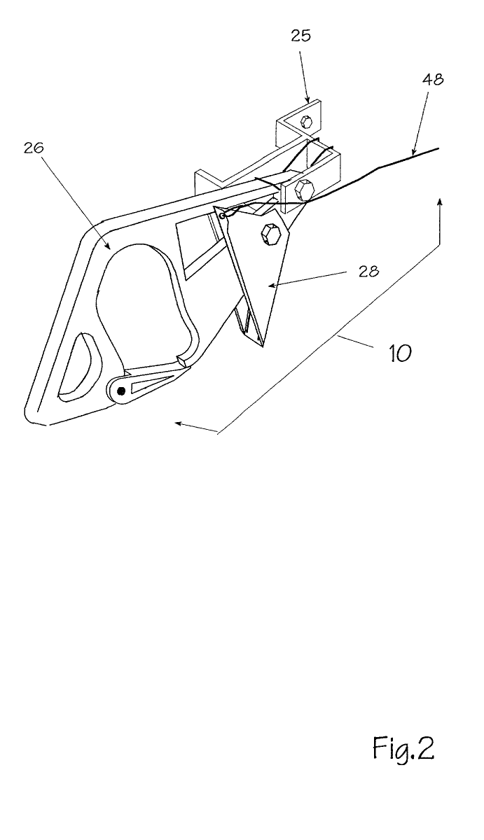

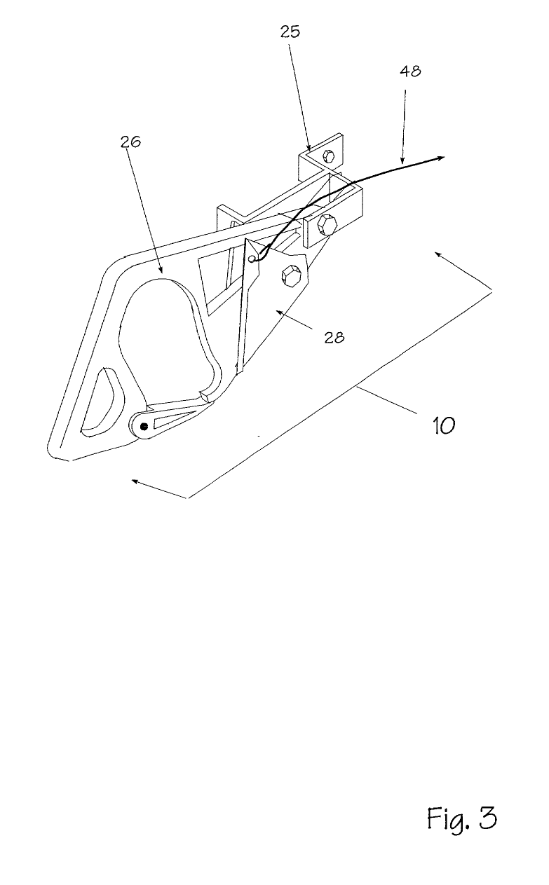

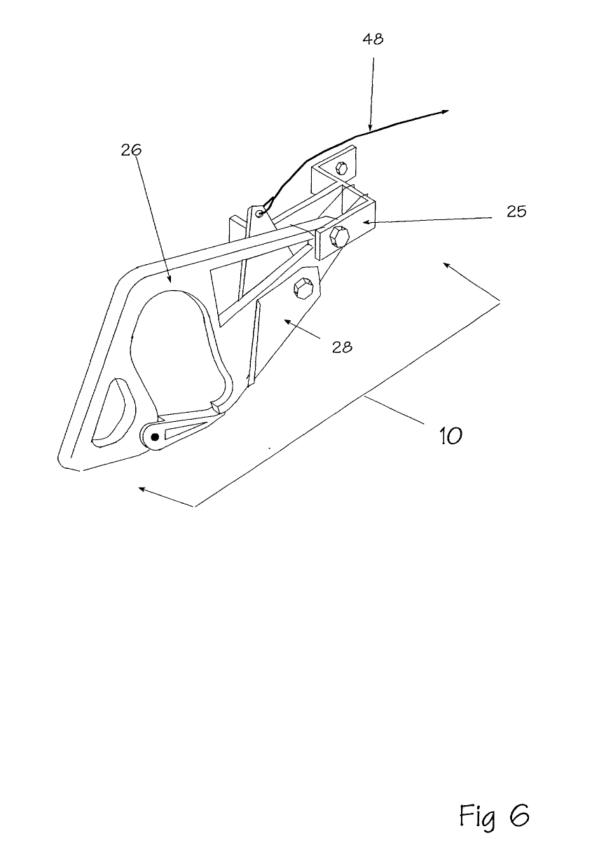

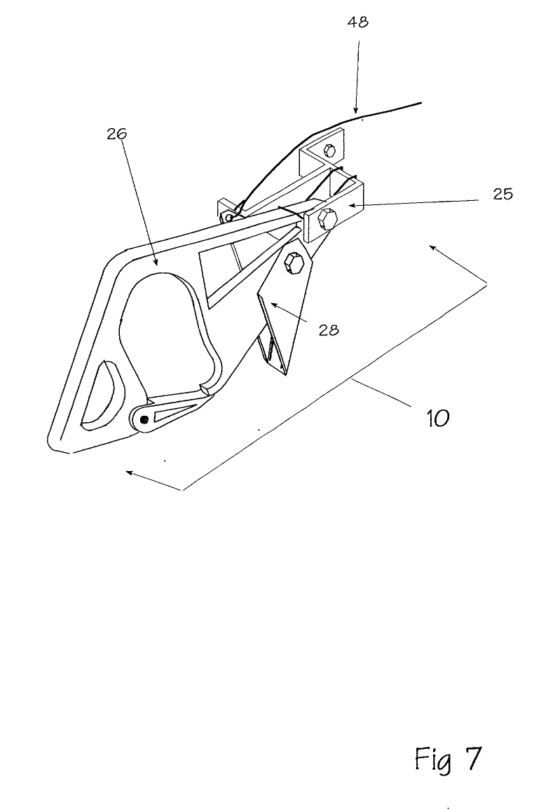

Referring to FIGS. 1, 4, and 5, the safety latch device 10 of the present invention 11 is a spring-loaded latch member 28 movable from a released position (FIG. 3, FIG. 7) to a tensioned position (FIG. 2, FIG. 6). The latch member 28 of the safety latch device 10 of the present invention is a substantially U-shaped plate having a first side wall 30, a second side wall 32 facing the first side wall 30, a middle wall 34 between and connected the first side wall 30 to the second side wall 32.

A channel 36 is defined between the first side wall 30 and the second side wall 32 for receiving at least a portion of the rung lock 26 in both the released position and the tensioned position. A first flange 38 extends from the first side wall 30 and a second flange 40 extends from the second side 32 wall for contacting the desired base rung 18 in the released position. Actual operation of the safety latch device 10 will be described in further detail below.

As illustrated in FIGS. 2 and 6, the latch member 28 is constructed and sized to pivot away from contact with one of the base section rungs 18 when the safety latch device 10 is in a tensioned position such as when the extension ladder 12 is being extended. As illustrated in FIGS. 3 and 7, the latch member 28 pivots into contact with one of the base section rungs 18 in the released position.

A pivot mechanism 42, e.g., a nut and bolt, a screw, etc., extends through a pivot aperture 44 in the first side wall 30 and the second side wall 32 thereby maintaining the connection between the latch member 28 and the extension ladder 12. The pivot mechanism 42 allows at least a portion of the latch member 28 to pivot to the released position and allowing the latch member 28 to pivot substantially completely away from one of the base section rungs 18 in the tensioned position. Furthermore, the middle wall 34 of the latch member 28 limits the rotational extent of the latch member 28 upon contacting one of the base section rungs 18. A spring mechanism 46 or other biasing means mounted about the pivot mechanism 42 biases the latch member 28 into the released position.

In operation of the safety latch device 10 of the present invention, the ladder lift rope 48 is connected to the latch member 28 through an aperture 50 in either the first flange 38 of the first side wall 30 or the second flange 40 of the second side wall 32. In the released position (when there is no positive tension or pulling of the lift rope 48), the latch member 28 is biased by the spring mechanism 46 and is released to contact the base section rung 18. When tension is applied to the lift rope 48 to raise or lower the extension ladder sections, the bias of the spring mechanism 46 is overcome and the latch member 28 is rotated about the pivot point out of contact with the base section rung 18 thereby allowing the ladder sections to move relative to each other.

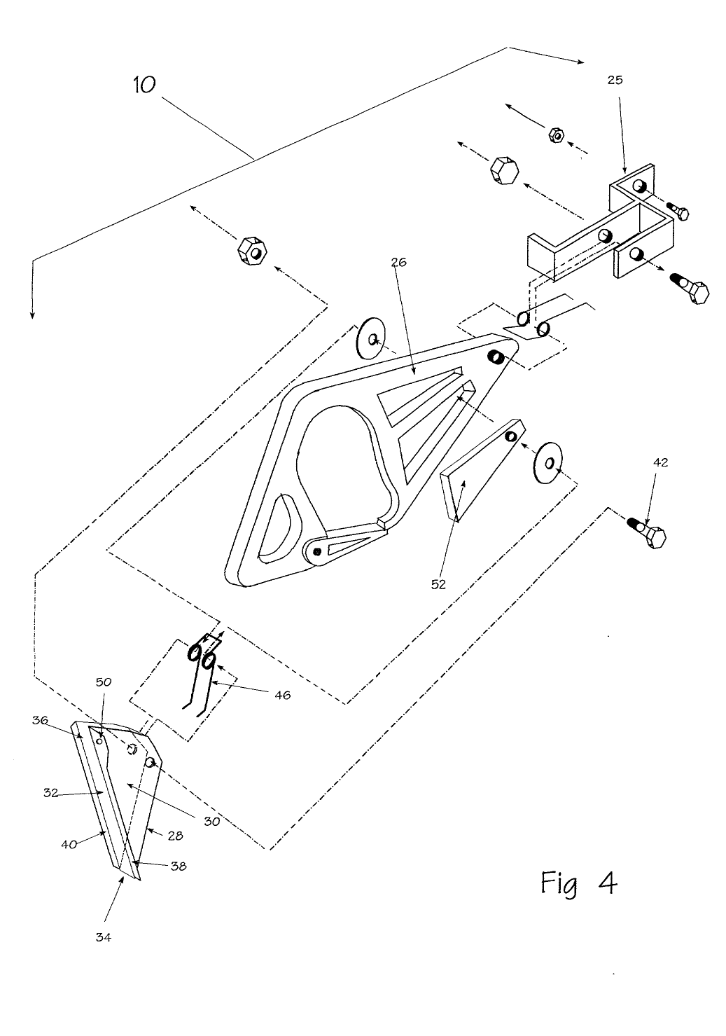

As illustrated in FIG. 4, the safety latch device 10 further includes a plate 52 securable within the rung lock 26. The latch mechanism 28 is then secured to the plate 52 by the pivot mechanism 42. The plate 52 is preferably sized and shaped to fit within an opening formed in the rung lock 26.

Preferably, in all of the embodiments of the present invention, the safety latch device 10 is constructed from a galvanized or stainless steel material. It should be noted, however, that it is within the scope of the present invention to construct the safety latch device 10 from other materials including, but not limited to, aluminum, plastic, fiberglass, ceramic, stainless steel, galvanized steel, etc.

With the safety latch device 10 of the present invention, accidental closing resulting from failure of the spring-biased rung locks, a movement or moving of the extension ladder by the user when on a roof, an extension ladder location change or relocation resulting from ladder lean or instability, or any of a variety of factors which do contribute to rung lock failure is eliminated. Both reductions substantially reduce, if not entirely eliminate, the injury potential to the users resulting from unintended fly section retraction or closure.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed is:

1. An extension ladder assembly, the extension ladder assembly comprising:
a base section having a pair of base section rails and a plurality of base section rungs mounted between the base section rails;
at least one fly section having a pair of fly section rails and a plurality of fly section rungs mounted between the fly section rails;
at least one rung lock secured to at least one of the fly section rails and selectively, releasably positionable about at least one base section rung to inhibit movement of the fly section in a generally downward direction;
a latching member rotationally mounted to each rung lock, the latching member selectively movable from a released position to a tensioned position; and
biasing means for biasing the latching member into the released position;
wherein in the released position, the latching member contacts the same base section rung as each corresponding rung lock.

2. The extension ladder assembly of claim 1 wherein the latching member has a substantially U-shaped cross-sectional configuration.

3. The extension ladder assembly of claim 2 wherein the latching member has a first side wall and a second side wall separated by a middle wall, the first wall and the second wall defining a channel.

4. The extension ladder assembly of claim 3 wherein at least a portion of the rung lock is receivable within the channel of the latching member.

5. The extension ladder assembly of claim 3 wherein the first side wall has a first extended flange and the second side wall has a second extended flange, the flange contactable with the base section rung when the latching member is in the release position.

6. The extension ladder assembly of claim 1 and further comprising:
limiting means for limiting the rotational extent of the latching member into the released position.

7. The extension ladder assembly of claim 1 and further comprising:
actuating means connected to the latching member for actuating the latching member into the tensioned position from the released position.

8. The extension ladder assembly of claim 7 wherein the actuating means is a rope graspable by a user and movable in a direction away from the latching member causing the latching member to move into the tensioned position.

9. The extension ladder assembly of claim 1 wherein the latching member is rotationally connected to the rung lock with a bolt extending through both the latching member and the rung lock.

10. A latching system for inhibiting unintentional retraction of an extension ladder, the extension ladder having a base section and at least one fly section extendible from a preceding section, the base section having a pair of base section rails and a plurality of base section rungs mounted between the base section rails, each fly section having a pair of fly section rails and a plurality of fly section rungs mounted between the fly section rails, the latching system comprising:
at least one rung lock securable to at least one of the fly section rails and selectively, releasably positionable about at least one base section rung to inhibit movement of the fly section in a generally downward direction;
latching means connected to each rung lock for contacting the same base section rung as the associated rung lock;
tensioning means for applying tension to the latching means; and
rotating means for rotating the latching means into contact with the base section rung upon release of the tension.

11. The latching system of claim 10 wherein the latching means is a substantially U-shaped member defining a channel.

12. The latching system of claim 11 wherein at least a portion of the rung lock is receivable within the channel of the member.

13. The latching system of claim 1 and further comprising:
limiting means for limiting the rotational extent of the latching member into the released position.

14. The latching system of claim 10 wherein the tensioning means is a rope graspable by a user and movable in a direction away from the member causing the member to move into the tensioned position.

15. A method for inhibiting unintentional lowering of a fly section of an extension ladder with respect to a base section of the extension ladder, the base section having a pair of base section rails and a plurality of base section rungs mounted between the base section rails, the fly section having a pair of fly section rails and a plurality of fly section rungs mounted between the fly section rails, the method comprising:
mounting at least one rung lock to at least one of the fly section rails;
contacting one of the base section rungs with the rung lock;
mounting a latching member to at least one of the rung locks;
biasing the latch member into a tensioned position; and
pivoting the latch member into a released position contacting the same base section rung as the rung lock.

16. The method of claim 15 and further comprising:
forming the latching member into a substantially U-shaped cross-sectional configuration.

17. The method of claim 16 and further comprising:
defining a channel within the latching member; and
receiving at least a portion of the rung lock within the channel of the latching member.

18. The method of claim 15 and further comprising:
limiting the rotational extent of the latching member into the released position.

19. The method of claim 15 and further comprising:
actuating the latching member into the tensioned position from the released position.

20. The method of claim 15 and further comprising:
rotationally connecting the latching member to the rung lock.
